(19) United States
(12) Patent Application Publication
(10) Pub. No.: US 2013/0332305 A1
(43) Pub. Date: Dec. 12, 2013

(54) SYSTEM AND METHOD FOR GENERATING REVIEW SCORES FOR CONSUMER PRODUCTS AND SERVICES

(71) Applicant: Greg Palmer, San Jose, CA (US)

(72) Inventor: Greg Palmer, San Jose, CA (US)

(21) Appl. No.: 13/491,505

(22) Filed: Jun. 7, 2012

(51) Int. Cl. G06Q 30/06; G06Q 30/02

(52) U.S. Cl. 705/26.7; 705/347; 705/27.2

(57) ABSTRACT

The present invention discloses a system and method for generating and displaying review scores. The method includes obtaining product information of a consumer electronics product. The product information includes at least one metric. Further, the method includes utilizing the at least one metric to generate a consumer review score of the consumer electronics product.

### FIELD OF INVENTION

This invention relates generally to consumer product and service reviews, and more particularly, to generating and displaying review scores of consumer products and services.

### BACKGROUND OF THE INVENTION

Technology is increasing the complexity of consumer products and services to a degree that many consumers are having difficulty distinguishing between similar products and services in the marketplace. For example, smartphones are being sold at record numbers but many consumers lack a basic understanding regarding the hardware and software product features to make an informed decision on which smartphone best meets their individual needs.

In fact, companies are allocating significant resources to market their products and services. The result is that many companies' branding and marketing campaigns are influencing consumers purchasing decisions before consumers understand the basic distinctions between products and services within a specific market category. However, these efforts do not necessarily provide the greatest benefit to consumers—which is to purchase the best product within a given price range to meet consumer needs.

There are, however, agencies which inform consumers about products and services in the marketplace. Typically, these reviews are merely subjective accounts of journalists' experiences with a particular product or service. A subjective review and analysis of consumer products may not be as effective because of technology advancements. Accordingly, consumers are increasingly having difficulty distinguishing between products and services and are instead relying more on branding and marketing campaigns when making purchasing decisions. As such, there exists a need for a more objective review system of consumer products and services. The present invention addresses such a need.

### SUMMARY OF THE INVENTION

The present invention discloses a system and method for generating and displaying review scores. The method includes obtaining product information of a consumer electronics product. The product information includes at least one metric. Further, the method includes utilizing the at least one metric to generate a consumer review score of the consumer electronics product.

The present invention further includes a method for generating and displaying review scores for services. The method includes determining a service's primary purpose(s). In an embodiment, the method further includes determining a service's secondary purpose(s) as well. Next, establishing service metrics associated with service offerings of a service. Further, the method includes determining an equation using the at least one of the service metrics to compute a score.

In one aspect of the present invention, a method includes obtaining specifications of at least one display wherein the specifications include at least one performance metric. Further, inputting the values of the at least one performance metric into an algorithm. Finally, utilizing the algorithm to generate an objective quality index score.

In another aspect of the present invention, a system and method includes comparing consumer electronics products. The method includes obtaining specifications of at least two consumer electronics products wherein the specifications include at least one performance metric associated with each consumer electronics product. The method further includes inputting the values of the at least one performance metric into an algorithm. Utilizing the algorithm to generate an objective quality index score for each consumer electronics product. Comparing the objective quality index score of each consumer electronics product. Finally, ranking each consumer electronics product based upon comparing each objective quality index score.

In yet another aspect of the present invention, a system and method includes a computer program operable to retrieve prices of at least two or more consumer electronics products or services within a single product category. The computer program is further operable to compute an objective quality index score of the consumer electronics products or services.

In addition, the present invention includes a method of deriving an algorithm for computing an objective quality index score. The method includes determining a feature of a product. The feature is a feature consumers consider when deciding to purchase the product or other products within the same product category. Further, obtaining the specifications of the product wherein the specifications include at least one performance metric. Selecting any of the at least one performance metric which has a significant effect on the feature. Inputting the value of the at least one performance metric into an algorithm. In an embodiment, the performance metric significantly effects the performance of the feature. Finally, utilizing the algorithm to compute an objective quality index score of the product.

Other aspects of the invention will become apparent from the following detailed description, taken in conjunction with the accompanying drawings, illustrating by way of example, the principles of the invention.

### BRIEF DESCRIPTION OF THE FIGURES

For a fuller understanding of the nature and objects of the invention, reference should be made to the following detailed description taken in connection with the accompanying drawing forming a part of this specification and in which similar numerals of reference indicate corresponding parts in all the figures of the drawing:

FIG. 1 illustrates a prior art consumer review site.

FIG. 2 illustrates a prior art consumer review of a consumer electronics product.

FIG. 3 illustrates a flowchart of a method for computing a quality index score.

FIG. 4 illustrates a perspective view of a first graph having points representing various consumer electronics products in accordance with a system and method of the present invention.

FIG. 5 illustrates a perspective view of a second graph having points representing consumer electronics products in accordance with a system and method of the present invention.

FIG. 6 illustrates a perspective view of a third graph having points representing consumer electronics products in accordance with a system and method of the present invention.

FIG. 7 illustrates a perspective view of a fourth graph having points representing consumer electronics products in accordance with a system and method of the present invention.

FIG. 8 illustrates a perspective view of a graph having a model displayed thereon in accordance with a system and method of the present invention.

FIG. 9 illustrates a perspective view of a graph having points representing consumer electronics products on a subjective review score and price axes.

FIG. 10 illustrates a perspective view of a graph having points representing consumer electronics products on a consumer review score and price axes.

FIG. 11 illustrates a perspective view of a website which appears after a purchase button was selected by a user in accordance with a system and method of the present invention.

### DETAILED DESCRIPTION

This invention relates generally to consumer product and service reviews, and more particularly, to generating and displaying consumer review scores of consumer products and services. The following description is presented to enable one having ordinary skill in the art to make and use the embodiment described herein and is provided in the context of a patent application. The generic principles and features described herein will be apparent to those skilled in the art. Thus, the present embodiment is not intended to be limited to the embodiments shown, but is to be accorded the widest scope consistent with the principles and features described herein.

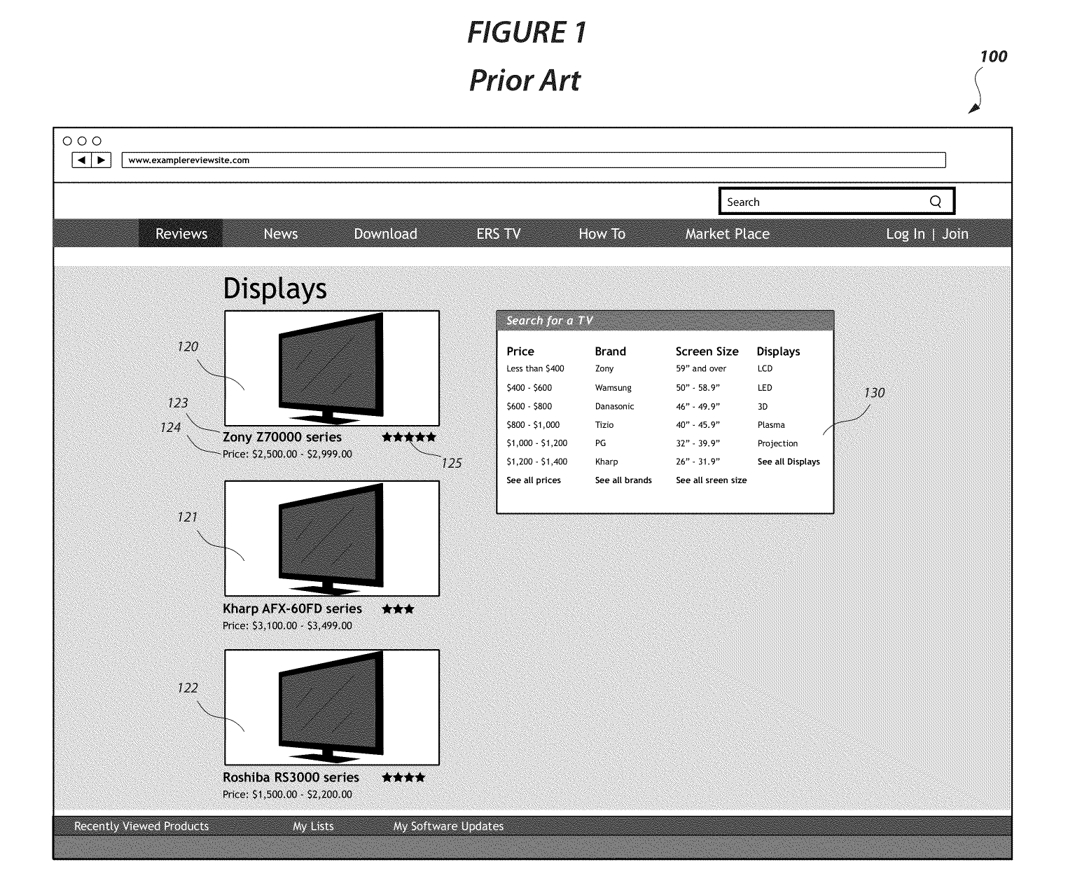

FIG. 1 illustrates a perspective view of a prior art consumer review site 100—www.examplereviewsite.com. Review site 100 features an index 130 of information such as price, brand, screen size, and display types of consumer electronics products reviewed. Furthermore, the review site 100 features three television set models 120, 121, and 122. Beneath the image of each television model are the manufacturer's name, model series, and price. For example, FIG. 1 indicates that television model 120 is manufactured by Zony, is the Z70000 series, and has a retail price between $2,500.00 and $2,999.00. FIG. 1 further shows the rating of the product.

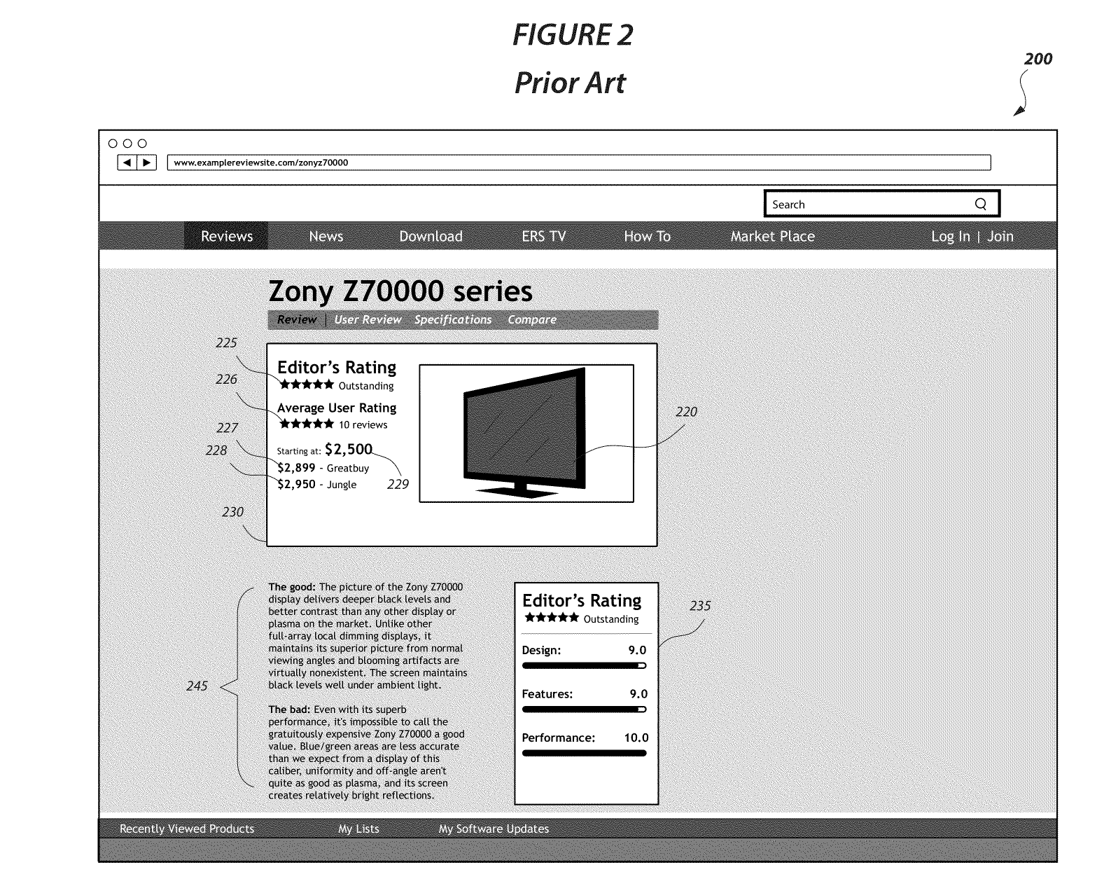

FIG. 2 illustrates a perspective view of a prior art consumer review of a consumer electronics product. FIG. 2 provides more information about the Zony Z70000 television model listed on the review site 100 illustrated in FIG. 1. As shown, this particular television model received a five-star rating as “Outstanding” by reviewers associated with the site 200. In addition, the Zony Z70000 television series received an average five-star user rating from members of the review site 200.

Price information is further illustrated in the figure. For example, according to the information displayed, the Zony Z70000 television series starts at $2,500 and can be purchased at Greatbuy for $2,899.00 and at Jungle for $2,950.00. With this information, visitors of the review site 200 can choose where to purchase the products.

Review site 200 also features an Editor's Rating column 235 area detailing how the product's overall editor's rating was generated. As shown, editors of the review site assigned the Zony Z70000 television series scores of 9.0/10 for design, 9.0/10.0 for features, and 10.0/10.0 for performance.

Further, editor(s) of the review site provided a product review 245 of the Zony Z70000 television series. The product review 245 lists both good and bad aspects of the featured product. For example, editor(s) commented that “[t]he picture of the Zony Z70000 [television series] display delivers deeper black levels and better contrast than any other display or plasma on the market.” However, they also commented that “[e]ven with its superb performance, it's impossible to call the gratuitously expensive Zony Z70000 a good value.”

As will be described below, the present invention includes a system and method of generating and displaying review scores of consumer electronic products. In particular, the present invention provides a method of utilizing product information of consumer electronic products and generating an objective quality index score which reflects the quality of each reviewed product. In an embodiment, the present invention utilizes a computer program to retrieve information about products within a product category. In particular, a computer program operating in accordance with the present invention retrieves price information, product images, and other pertinent information.

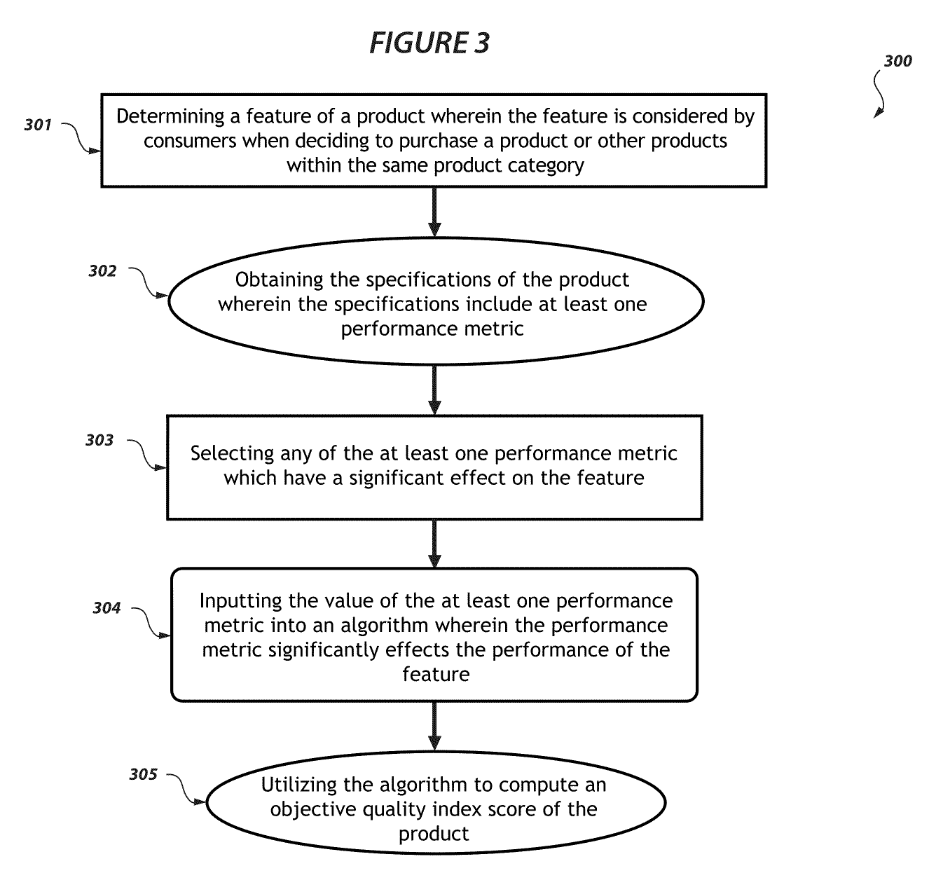

An objective quality index score may be derived by various methods. FIG. 3, for example, illustrates a flowchart 300 of a method for computing an objective quality index score. Block 301 provides determining a feature of a product wherein the feature is considered by consumers when deciding to purchase the product or other products within the same product category. Next, obtaining the product information of the product wherein the product information includes at least one performance metric. In an embodiment, product information is the product's specification as illustrated in Block 302. However, product information may include any source or literature which provides technical details of the product. For example, product information may include any of the following: specifications, datasheets, whitepapers, product manuals, product overviews and any other product documentation.

Further, it should be understood, however, that the present invention is not limited to retrieving performance metrics from information within the product's specification. For example, one may create customized performance tests to generate performance metrics, take two or more performance metrics within the product's specification to create a unique performance metric, or include any other method so long as the method is consistently used to test performance of products within the same product category.

Moving down flowchart 300, block 303 provides selecting any of the at least one performance metric which have a significant effect on the feature. Next, inputting the value of the at least one performance metric into an algorithm wherein the performance metric significantly effects the feature's performance—block 304. Finally, block 305 provides utilizing the algorithm to compute an objective quality index score of the product.

It should be understood that the present invention is not limited to providing a scoring system for consumer products. Accordingly, the present invention includes a review and scoring system for services as well. For example, the present invention can be applied to provide a method of generating and displaying a review score for an internet search engine.

In an embodiment, the method includes determining the services primary purpose: generating the most relevant information to a user based upon a submitted search query. Next, the method includes determining services metrics. For example, for internet search engine services, the service metrics include obtaining the number of websites and other information online accessible to the search tool. Further, the method includes determining an equation using at least one of the service metrics to compute a score. The computed score, in an embodiment, provides an indication of the relevancy of the retrieved results based on a search query. In yet another embodiment, the computed score indicates the time the search engine renders the results. Accordingly, a system and method of the present invention can also include a review and scoring system for services.

In an embodiment, a method of generating an objective quality index score includes inputting values of metrics obtained from the specifications of a consumer electronics product into an algorithm. For example, when the consumer electronics product includes a display device such as a television or computer monitor, the performance metrics used to compute an objective quality index score are the following: perceived resolution, perceived color, perceived frames per second, and distortion time. In an embodiment, the equation used to compute an objective quality index score of the consumer electronics product is the following:

Objective Quality Index Score=(Perceived resolution factor)*(Perceived color factor)*(Perceived frames factor)*(Distortion time factor) Equation 1:

In an embodiment of the present invention, the “factors” in Equation 1 are not the actual values of the performance metrics. For example, the perceived resolution factor variable in Equation 1 is not the actual value of the perceived resolution found in the product's specifications but is computed using the perceived resolution value. In addition, Equation 1 provides that the product of the “factors” produce a quality index score in the range of 0.0 to 1.0, according to an embodiment of the present invention.

In an embodiment of the present invention, a score of 1.0 is the highest score that can be given to a product, which indicates that the reviewed product has excellent quality. In contrast, a product with a score less than 0.5 indicates that the product's quality is very poor. In an embodiment of the present invention, any reviewed product with a quality index score greater than or equal to 0.65 is a product with at least satisfactory quality.

It should be understood, however, that the quality index score is not limited to a range from 0.0 to 1.0. As such, the quality index score(s) may fall within any number of ranges (e.g. 100-1000, etc.). In yet another embodiment, the quality index scores may be divided by a constant such that the resulting quotient is within a pre-determined desired range.

In an embodiment, a perceived resolution metric, located in a display product's specifications, is a measurement of the quantity of pixels per inch the average human can visually perceive. The perceived resolution metric is affected by a person's distance from the displays (e.g. television or computer monitor). Typically, as one gets closer to the display, one's perceived resolution increases. In contrast, one can expect the perceived resolution to decrease as one gets further away from the display. In an embodiment of the present invention, the perceived resolution factor is the ratio of the perceived resolution value and the real perceived value. See Equation 2 below:

Perceived resolution factor=(Perceived resolution value)/(real perceived value) Equation 2:

For example, if a computer monitor has 250 pixels per inch but an average person can only perceive 200 pixels per inch, the perceived resolution factor is 0.8 (200/250). As such, as an individual gets closer to a display device, the perceived resolution value increases.

Note, an individual may move close enough to a display that the perceived resolution factor exceeds the true or “real” resolution. For example, if the real number of pixels per inch for a video screen is 250 pixels per inch, one may get so close to the video screen that they may perceive more than 250 pixels per inch. In this event, the real resolution value of 250 pixels per inch is used instead of the perceived resolution value when computing the perceived resolution factor. For example, if the real perceived value of a computer monitor is 275 pixels per inch, the value used and inputted into the algorithm for computing the perceived resolution factor is 1.0 (250/250). Accordingly, the perceived resolution factor is a function of the perceived resolution value which is determined by the distance a user is expected to be away from a display according to an embodiment of the present invention.

As such, if the true resolution is greater than the perceived resolution, the value used and inputted into the algorithm for computing the quality index score is the ratio of the perceived resolution and the true resolution value. Alternatively, if the perceived resolution is greater than or equal to the true resolution value, the perceived resolution factor is 1.0.

Moving forward, the perceived color factor reflects the amount of color contrast human beings can detect from a commercial display product. The color contrast is the difference in luminance and/or color that makes an object (or its representation in an image or display) distinguishable. For example, human beings can perceive very high contrast ratios of over 10,000,000:1 colors. If the limitation of color contrast for commercial products are 10,000:1 (the brightest white vs. the darkest dark), the amount of colors an individual perceives projected from a display is a function of the color contrast provided in the display's specifications. The equation for computing the color contrast factor is provided by Equation 3 below:

Perceived color factor=(Product's color contrast)/[(Peak commercial product color contrast)*(Number of colors detectable by humans)] Equation 3:

For example, if a display has a color contrast of 1,000:1, the limitation of color contrast of most commercial displays is approximately 10,000:1, and the peak amount of colors perceived by humans is 10,000,000, then the amount of colors which can be projected by this display is: (1,000)/(10,000)*(10,000,000)=1,000,000 colors.

Next, the perceived frames factor can be obtained from the perceived frames per second metric which is the amount of frames per second perceived by the average human. As the number of perceived frames per second increases, the greater amount of frames an individual can perceive. However, at a certain point, the number of frames perceived by a human reaches a limit. More specifically, there is a point where additional frames per second are not perceivable to humans. The perceived frames factor is shown in Equation 4 below:

Perceived frames factor=(Perceived frames per second)/(Limit of frames per second perceived by humans) Equation 4:

Moving forward, the distortion factor is derived from the distortion time. The distortion rate is a measurement of the amount of distortion (e.g. “ghosting”) that lasts after a pixel change colors. Typically, as a pixel changes color, a signature or tail of the pixel color remains displayed afterwards for a period of time. If a pixel changes colors such that the amount of distortion remains less than five milliseconds, the pixel distortion is undetectable to the average human. Accordingly, commercial display devices boasting distortion pixel rates less than or equal to five milliseconds are assigned a distortion factor of 1.0. The equation for computing the distortion factor is shown by Equation 5 below:

Distortion factor=(5 ms)/(distortion time of commercial product) Equation 5:

Moving forward, a subjective review score may be obtained simply by grading a consumer electronics product after using the product. For example, one can grade a product based upon his or her overall impression of the product without basing the review on any scientific analysis. Accordingly, a computer program operating according to a system and method of the present invention can produce an overall consumer review score for consumer electronics products from both a subjective review score and an objective quality index score. As such, an overall consumer review score may include a subjective review score component and an objective quality index score component.

It should be understood that the present invention is not limited to a consumer review score with a subjective review score. As such, a consumer review score may comprise only an objective index score component and this would be in the spirit and scope of the present invention. In an embodiment, 90% of the consumer review score is made up of an objective quality index score and 10% of the consumer review score is made up of a subjective review score such that a consumer review score is 90% objective and 10% subjective.

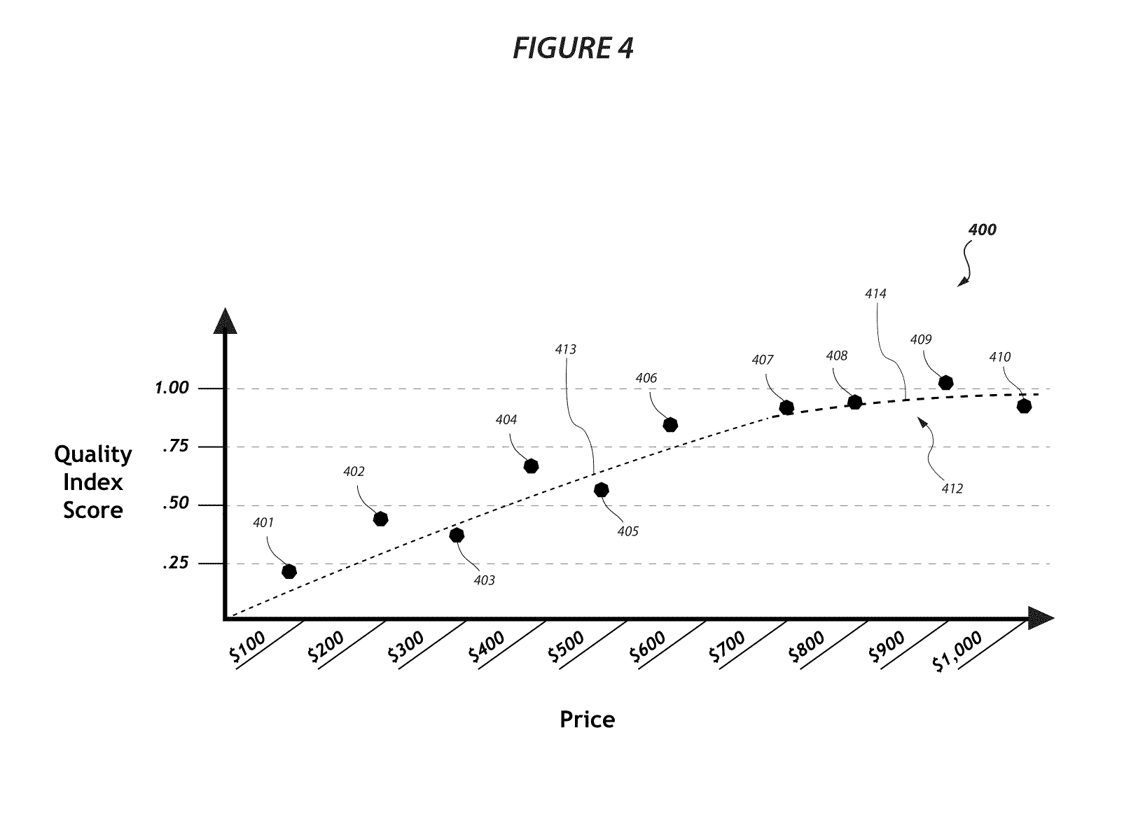

Moving forward, FIG. 4 illustrates a perspective view of a first graph 400 displaying the coordinates of the objective quality index score and price of each reviewed consumer electronics product. As shown, the objective quality index score and price of each reviewed consumer electronics product are displayed together on one pane (e.g. graph 400). On the figure, nine points, 401-409, are shown representing nine individually reviewed consumer electronics products. In an embodiment, points 401-409 represent computer monitors. However, it should be understood that the present invention is not limited to any particular product or service category. As such, any product or service which can be reviewed objectively is within the spirit and scope of the present invention.

FIG. 4 illustrates that graph 400 has two axes, a quality index score axis and a price axis such that graph 400 readily reveals the quality index score and price of each reviewed computer monitor. For example, point 401 represents a computer monitor which has a quality index score and price of 0.25 and $100, respectively. On the other end of the spectrum is point 410 which represents a computer monitor having an objective quality index score and price of approximately 0.9 and $1,000.

In an embodiment of the present invention, the prices shown in FIG. 4 are exemplary retail prices of computer monitors sold in the marketplace. In yet another embodiment, the prices shown are wholesale prices. Accordingly, the displayed prices retrieved by a computer program operating according to a system and method of the present invention may be any type of price so long as all of the prices of the reviewed consumer electronics products are consistent. For example, all of the prices of the reviewed consumer electronics products are either retail prices or wholesale prices.

In addition, the prices of each reviewed consumer electronics products shown in the figure may be retrieved from or obtained by various tools and methods such as an online search tool. Price information may also be obtained from a database, website, or from any computer readable medium. In an embodiment, prices of consumer products may be retrieved by using an API to Google's Product Search tool. Once a list of prices for a particular product is obtained, the lowest price of the product can be selected by the computer program and displayed in the graph according to an embodiment of the present invention. It should be understood, however, that the present invention is not limited to retrieving a product's lowest retail price. The highest, mean, median, or any other price metric obtained from the list of prices may be used. In the embodiment shown, the prices for the products are the lowest retail prices retrieved.

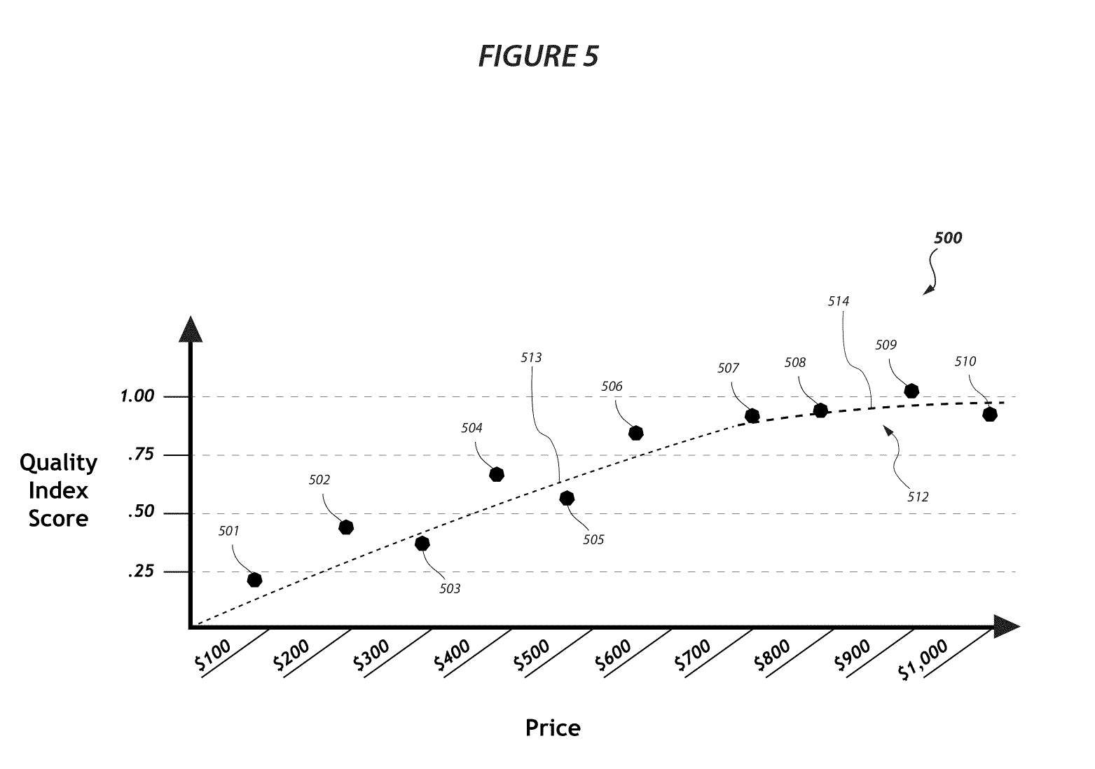

Moving on to the next figure, FIG. 5 illustrates a perspective view of a second graph 500 having points representing consumer electronics products in accordance with a system and method of the present invention. As shown, graph 500 includes a plurality of points representing consumer electronics products such that the objective quality index score and price of each product are revealed.

Graph 500 includes a trend line 512 showing the trend of prices and quality index scores of the reviewed consumer electronics products. As further shown, trend line 512 has two components—trend line component 513 and trend line component 514. Trend line component 513 extends from the origin of graph 500 to point 507 whereas trend line component 514 extends from point 507 to point 510.

In the embodiment shown, trend line component 513 is approximately linear which indicates that the quality of the consumer electronics products within this region increases approximately linearly with price. As such, a buyer that pays more for a consumer electronics product within this region generally gets a noticeably better product.

As further shown, the curve of trend line 512 becomes less linear and tends to flatten out from points 507 to 510—trend line component 514. A buyer that spends more money for a consumer electronics product within this region generally obtains a marginally better product. Accordingly, corporate branding, marketing, and advertising campaigns best explain the reason consumers purchase products within this area of trend line 512.

It should be understood that not all of the points illustrated on graph 500 are on the trend line 512. In fact, some of the points may be so far away from the other points that they were not taken into account to form the trend line 512. As such, trend line 512 is an approximation and may be considered a best fit curve, according to an embodiment of the present invention.

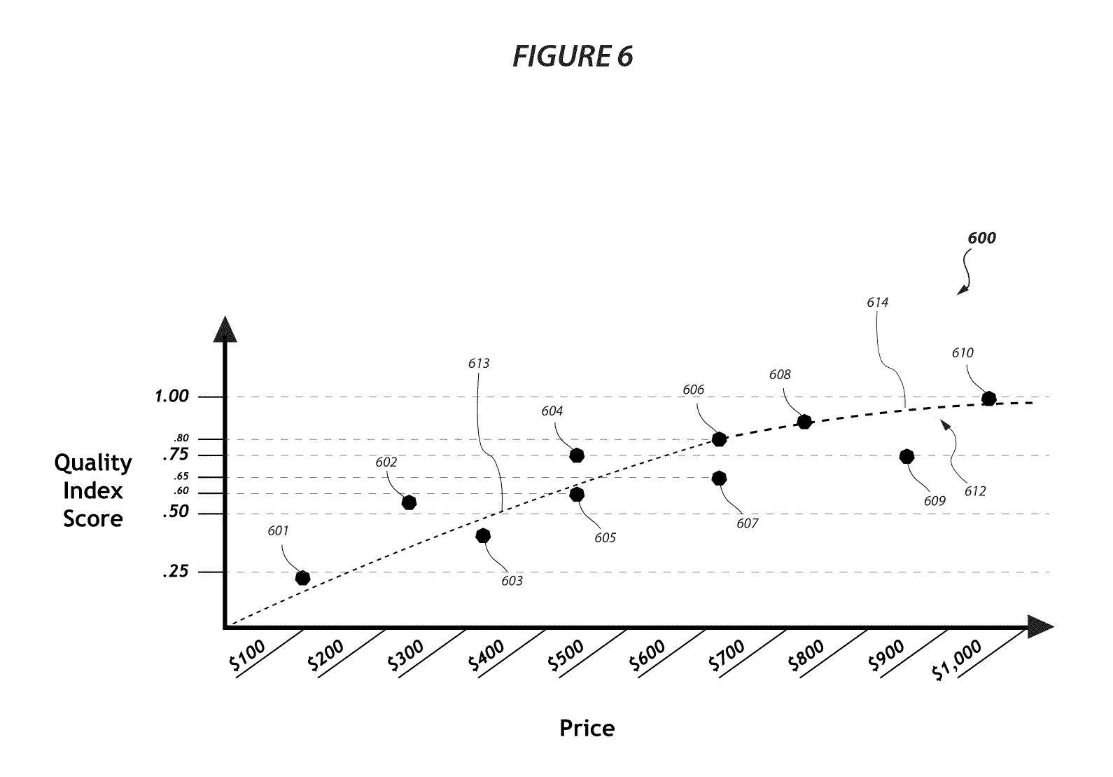

Continuing on through the figures, FIG. 6 illustrates a perspective view of a third graph 600 having points representing consumer electronics products in accordance with a system and method of the present invention. As shown, graph 600 also has a trend line 612 which is a best fit curve of the points displayed in graph 600. Trend line 612 has two components—trend line component 613 and trend line component 614 each having different slopes.

Some of the points displayed in graph 600 have the same price despite having different quality index scores. For example, points 604, 605 represent computer monitors which each cost $450 and have quality index scores of 0.75 and 0.60 respectively. In addition, points 606, 607 represent computer monitors price of $650 with quality index scores of 0.80 and 0.65 respectively.

In the event two or more points representing consumer electronics products have the same price, the objective quality index scores of the consumer electronic products can easily be compared. For example, the difference in objective quality index scores between points 604, 605 and 606, 607 are approximately 0.15. Accordingly, a consumer can utilize graph 600 to make a determination of which product to purchase.

In particular, a consumer that wants to purchase the best product within a product category at a certain price can utilize graph 600 to make an objective determination. For example, if a consumer wants to spend no more than $450 for a particular computer monitor such as the computer monitors represented in FIG. 6, a consumer may purchase the computer monitor represented by point 604 since it has the highest quality index score without being influenced by the product's commercial appeal.

For the same reason, if a consumer wants to spend no more than $650 for a computer monitor such as the computer monitors represented in FIG. 6, the consumer may purchase the computer monitor represented by point 606. As such, in the event multiple consumer electronics products within the same product category have the same price, the consumer electronics product with the highest quality index score may likely be purchased by consumers having access to a system and method of the present invention.

Now referring back to the previous examples, the computer monitor represented by point 604 may be classified as the “par product” for computer monitors which costs approximately $450. In addition, the computer monitor represented by point 606 may be classified as the “par product” for computer monitors which costs approximately $650.

In addition, a product may be classified as the “par product” among an entire category of products if the product is at the end of the linear component of the trend line displayed in the graph. For example, the “par product” of all of the reviewed monitors represented in graph 600 is the computer monitor represented by point 606. Ironically, the computer monitor represented by point 606 is also the “par product” with respect to the computer monitors sold at $650 (e.g. point 606 and 607). In contrast, the monitor represented by point 604 is the “par product” for computer monitors sold at $450 but would not be the par product for all of the reviewed monitors since point 604 is not at the end of the linear component 613 of trend line 612.

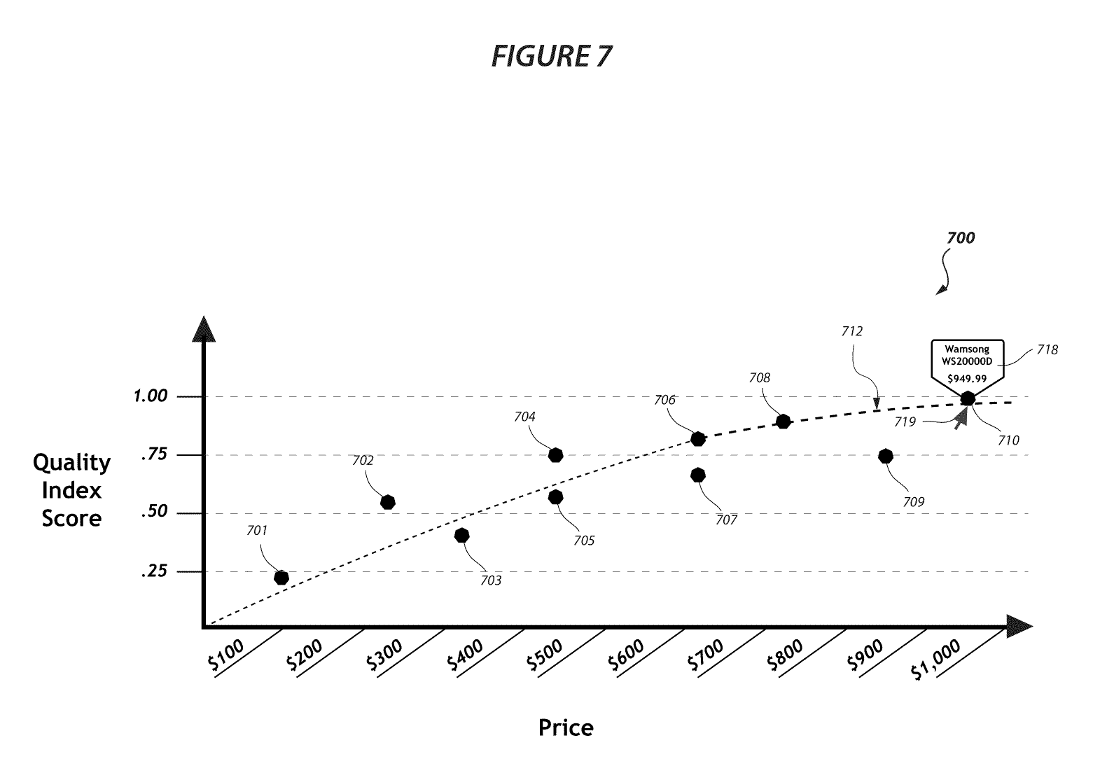

Continuing on through the figures, FIG. 7 illustrates a perspective view of a fourth graph 700 having points representing consumer electronics products in accordance with a system and method of the present invention. In particular, graph 700 is similar to graph 600 with regards to the position of the points on the graphs. FIG. 7, however, illustrates that a user causes a reviewed product's name and price to display. For example, moving a user's cursor 719 proximate to point 710 causes an image of a tag 718 (of the product represented by point 710) to hover over the point 710. The tag 718 indicates that the product represented by point 7010 is the Wamsong WS20000D which costs $949.99. In addition, if the user desires to view images of the represented commercial products, users can select the respective points on the graph.

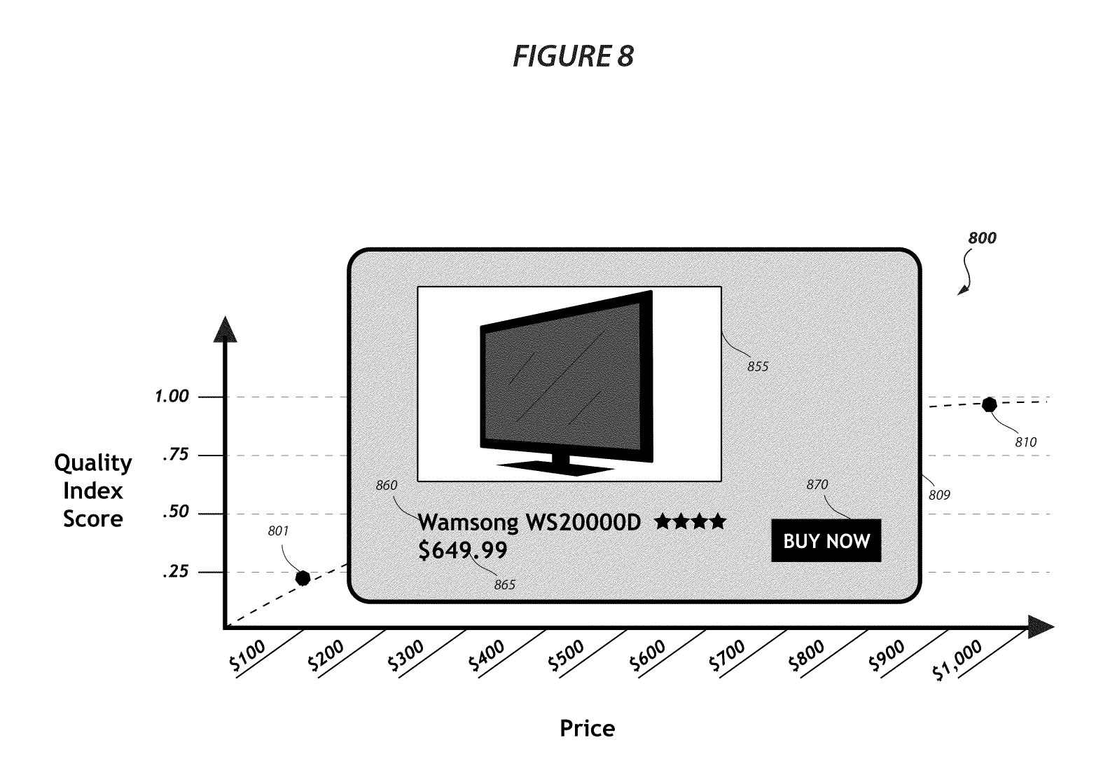

FIG. 8 illustrates a perspective view of a graph 800 having a model 809 displayed thereon in accordance with a system and method of the present invention. In an embodiment, a model 809 includes an image of a computer electronics product (e.g. computer monitor) displayed by a user via a point representing the product on a graph 800. In the embodiment shown, a user selection of point 706, illustrated in FIG. 7 displays the model 809 in FIG. 8. Model 809 is shown to include additional product information such as the product manufacturer's name (Wamsong WS20000D) 860 and price ($649.99) 865.

In the event a user selects purchase button 870, a website appears where a user can purchase the product from an online retailer, as further described below. In other embodiments, upon selecting purchase button 870, a website appears where a user can purchase the product from an online wholesaler, distributer, et cetera.

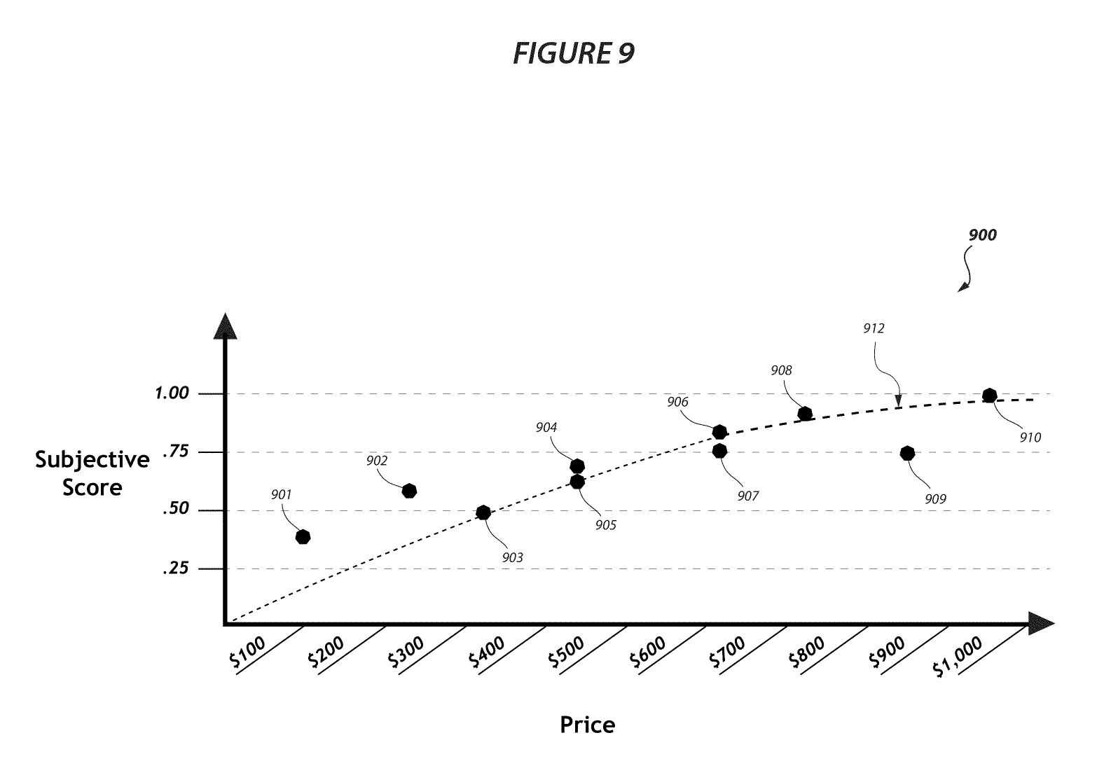

FIG. 9 illustrates a perspective view of a graph 900 having points (901-910) representing consumer electronics products on a subjective review score and price axes. As described above, the present invention is amenable to include a subjective review score component within the consumer review score. On graph 900, each point represents a reviewed consumer electronics products (e.g. computer monitors) and has a subjective review score and price. For example, the product represented by point 903 received a subjective review score of (0.50) 5/10 as indicated on the graph 900. Additionally, the product represented by product 910 received a subjective review score of (1.00) 10/10 as further indicated on the graph 900.

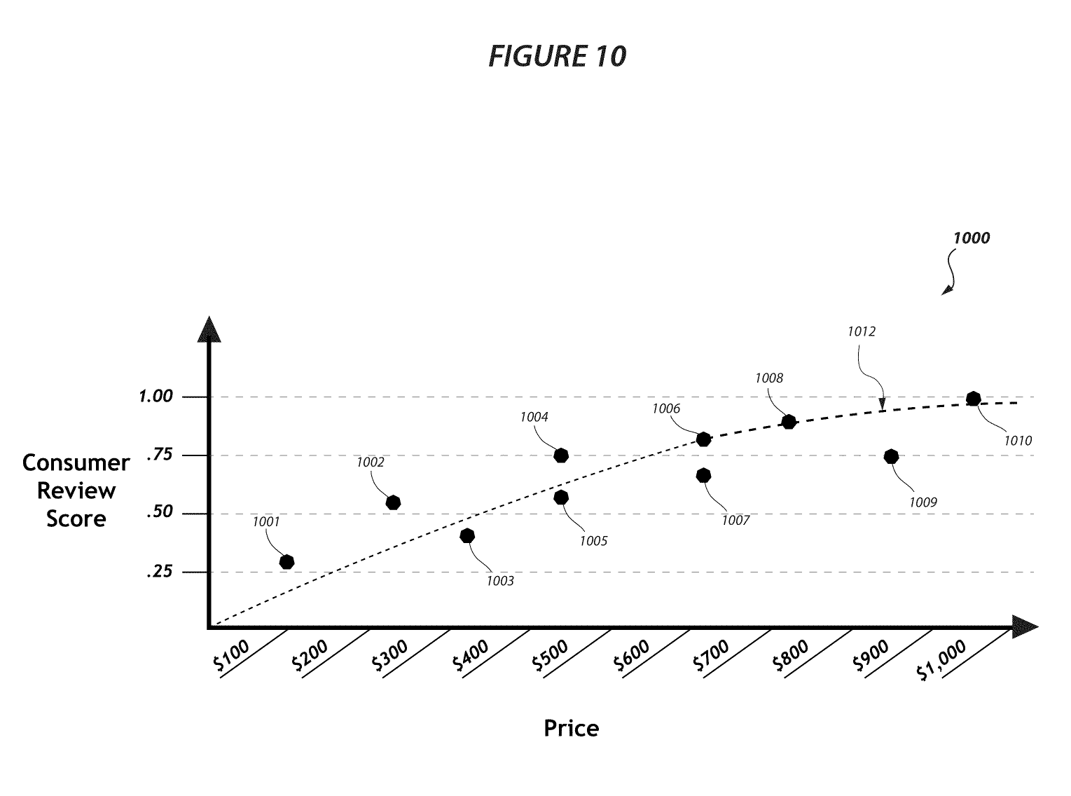

Continuing on through the figures, FIG. 10 illustrates a perspective view of a graph 1000 having points (1001-1010) representing consumer electronics products on a consumer review score and price axes. The figure illustrates the final consumer review score computed from both objective quality index and subjective review scores of each reviewed product. In particular, the consumer review scores illustrated in the figure is computed from both the objective quality index scores data shown in FIG. 7 and subjective review scores data shown in the previous figure (FIG. 9).

For example, point 1001 is representative of a reviewed computer monitor illustrated as point 701 in FIG. 7 and point 901 in FIG. 9. Point 701 of FIG. 7 illustrates that the objective quality index score of the first reviewed monitor is approximately 0.25 whereas point 901 of FIG. 9 illustrates that the subjective review score of this monitor is approximately 0.40. In an embodiment, the objective quality index score makes up 90% of the consumer review score and the subjective review score makes up 10% of the review score. Accordingly, the consumer review score of the first reviewed monitor is approximately 0.2650 as shown in FIG. 10.

In addition, after the consumer review scores are generated, the reviewed products can be compared and ranked. The reviewed products can also be ranked according to consumer review score, quality index score, subjective review score or any combination of the aforementioned scores per price.

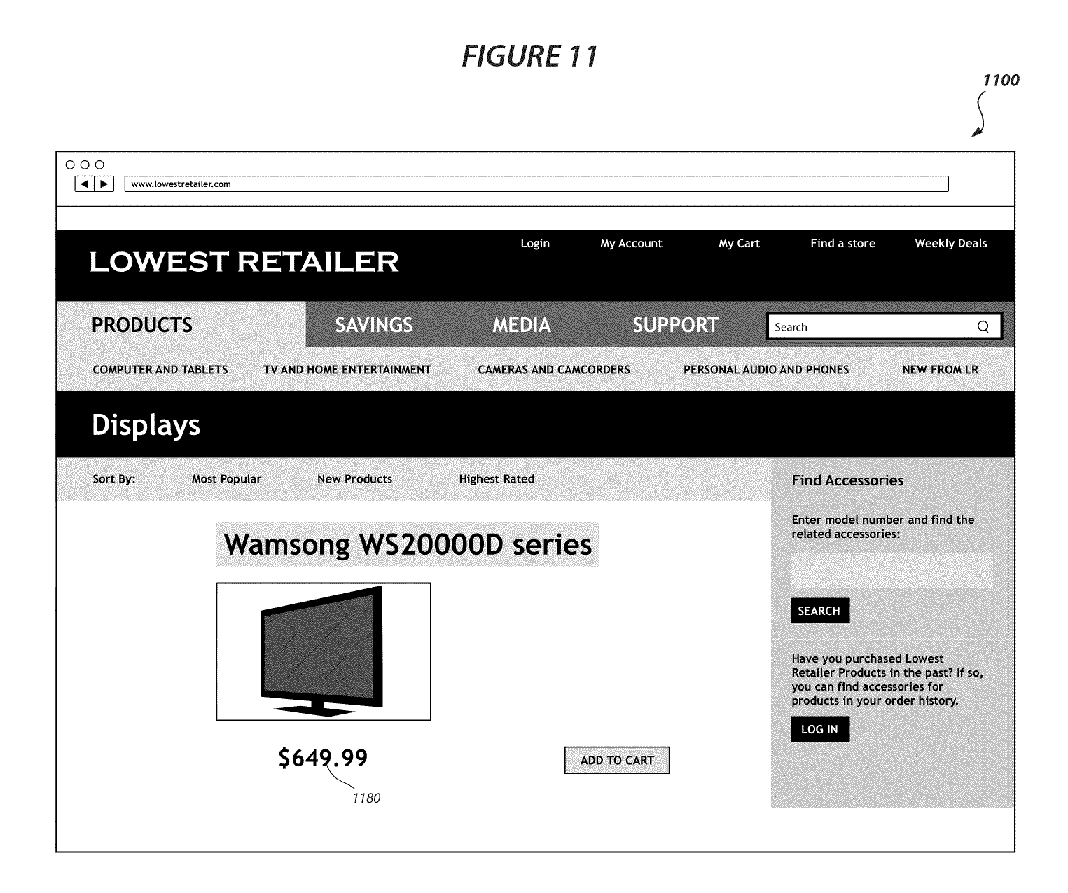

Moving forward, FIG. 11 illustrates a perspective view of a website 1100 which appears after a purchase button displayed on a model is selected by a user in accordance with a system and method of the present invention. Most notably, website 1100 provides a user an opportunity to purchase the Wamsong WS20000D computer monitor (represented by point 1006 in FIG. 10—par product) from the site 1100.

Accordingly, a system and method of the present invention can be used to retrieve price information, compute consumer review scores, create graphs, display price and quality index scores on the graphs, and provide links to websites selling each reviewed product or service.

A review system of products and services has been described. It will be understood by those having ordinary skill in the art that the present invention may be embodied in other specific forms without departing from the spirit and scope of the invention disclosed. In addition, the examples and embodiments described herein are in all respects illustrative and not restrictive. Those skilled in the art of the present invention will recognize that other embodiments using the concepts described herein are also possible.

I claim:

1. A method, comprising:
obtaining product information of a product wherein said product information includes at least one metric; and
utilizing said at least one metric to generate a consumer review score of said product.

2. The method of claim 1, wherein said product is a consumer electronics product.

3. The method of claim 1, wherein said consumer review score includes an objective quality index score.

4. The method of claim 1, wherein said at least one metric is a performance metric.

5. The method of claim 3, wherein said objective quality index score is generated by inputting values of said at least one performance metric into an algorithm.

6. The method of claim 5, wherein said at least one performance metric is any of the group comprising perceived resolution, perceived color, perceived frames per second, and distortion rate.

7. The method of claim 2 further comprising comparing said consumer review score of each consumer electronics product and ranking said consumer electronics product based upon said comparison.

8. The method of claim 2, wherein said consumer electronics product is any of the group comprising a television and a computer monitor.

9. The method of claim 1, wherein said consumer review score further includes a subjective review score component.

10. The method of claim 1, wherein said product information includes any of the group comprising a, datasheet, whitepaper, product manual, product overview, and specifications.

11. A method of rating a display, comprising:
obtaining specifications of at least one display wherein said specifications include at least one performance metric;
inputting the values of said at least one performance metric into an algorithm; and
utilizing said algorithm to generate an objective quality index score.

12. The method of claim 11 further comprising:
displaying said objective quality index score in relation to a price of said at least one display.

13. The method of claim 11, wherein said objective quality index score is displayed in relation to a price of said at least one display as a point on a graph.

14. The method of claim 11 further comprising displaying a second objective quality index score and a second price of a second display such that said objective quality index scores and said prices of said displays are displayable together on one pane.

15. The method of claim 12, wherein said price is retrieved from any of a database, website, or a computer readable medium.

16. The method of claim 12, wherein said price is the lowest retrieved retail price of said display.

17. The method of claim 16, wherein said lowest retrieved retail price is obtained by using an online search tool.

18. A method of comparing consumer electronics products, comprising:
obtaining specifications of at least two consumer electronics products wherein said specifications include at least one performance metric associated with each consumer electronics product;
inputting the values of said at least one performance metric into an algorithm;
utilizing said algorithm to generate an objective quality index score for each consumer electronics product;
comparing said objective quality index score of each consumer electronics product; and
ranking each consumer electronics product based upon comparing each objective quality index score.

19. The method of claim 18 further comprising comparing a lowest retrieved retail price of each consumer electronics product.

20. The method of claim 18, wherein each consumer electronics product is ranked according to a price per quality index score.

21. A system, comprising:
a computer program operable to retrieve prices of at least two or more consumer electronics products or services within a single product or service category wherein said computer program is further operable to compute an objective quality index score of said at least two or more consumer electronics products or services.

22. The system of claim 21, wherein said computer program is further operable to display at least two or more points wherein each point represents one of said at least two or more consumer electronics products on a single pane.

23. The system of claim 22, wherein said at least two or more points have coordinates which indicate the price and objective quality index score of each consumer electronics product.

24. The system of claim 22, wherein said at least two or more points are links to a website where an user can purchase said consumer electronics products.

25. The method of claim 21, wherein in the event any one of said at least two or more points is selected an image of said consumer electronics product represented by said point is displayed.

26. The method of claim 25, wherein said model includes a means to purchase said at least one of said consumer electronics products.

27. The method of claim 26, wherein said means to purchase said at least one consumer electronics product includes a purchase button displayed on said model.

28. The method of claim 21, wherein said at least one point represents a par product wherein said par product is a consumer electronics product with the highest quality index score for a category of consumer electronics products sold at a particular retail price.
